(19) United States
(12) Patent Application Publication
(10) Pub. No.: US 2023/0136059 A1
(43) Pub. Date: May 4, 2023

(54) ELECTRONIC DOCUMENT GENERATION AND EXECUTION

(71) Applicant: Citrix Systems, Inc., Fort Lauderdale, FL (US)

(72) Inventor: Vishal Dwivedi, Bangalore (IN)

(21) Appl. No.: 17/518,161

(22) Filed: Nov. 3, 2021

(51) Int. Cl. G06F 40/166; G06F 16/383; G06F 40/40; G06K 9/00

(52) U.S. Cl. CPC G06F 40/166; G06F 16/383; G06F 40/40; G06K 9/00469; G06K 2209/01

(57) ABSTRACT

A technique for document management includes performing a text-based analysis of a document submitted for signature and/or storage. The text-based analysis searches for terms and/or other content that indicate a future action to be performed and a corresponding action date by which to perform the action. In response to detecting such terms and/or other content, the technique further includes creating metadata indicative of the action and associated action date and storing such metadata in a database. The technique further includes querying the database, e.g., prior to or upon the action date, and creating a modified version of the document to implement the detected action.

### BACKGROUND

Electronic documents are quickly becoming the first choice of many businesses and other entities, which prefer them for their speed of execution, paperless processing, and added convenience. In a typical scenario, a user prepares a document for electronic signature. The user uploads the document to a document server and specifies one or more parties as signatories to the document, e.g., by providing their email addresses or cell phone numbers. The user may add one or more fields for data entry, and such fields may include one or more signature fields.

Once all the fields have been placed into the document, the user may submit the document for online execution. For example, the document server responds to the user's submission by sending an email or other communication to each specified party. The email or other communication may include a brief description of the document and a link to a version of the document prepared for the respective party's signature. A party clicks on the link, and a version of the document opens, e.g., in a browser or app on the party's computer or other device. The party can then review the agreement, enter any requested data into fields prepared for this purpose, and sign the document. The party may then submit the signed document, e.g., by clicking or tapping a button. Submitting the document returns the signed document to the document server, which may store the signed document for safekeeping.

### SUMMARY

Unfortunately, current document servers are unable to create new documents or new versions of documents. Rather, such document servers act as passive repositories or databases of documents created by users. The passive nature of document servers may be attributable at least in part to the prior lack of available technical tools for analyzing stored documents efficiently. It may also be attributable to providers failing to see the potential of stored documents in improving server operations and services. We have recognized, however, that document servers can play a more active role in improving server operations and user services. For example, modified versions of many documents can be predicted from the contents of the documents themselves. If a document server could create modified versions of documents, it would avoid user inconvenience as well as the computational burdens of responding to user requests to create new documents. What is needed, therefore, is a way of creating new documents by a document server in cases where the contents of the new documents can be predicted.

In contrast with prior approaches, an improved technique to identify documents in need of follow-up actions and to create new documents or versions thereof includes performing a text-based analysis of a document submitted for signature and/or storage. The text-based analysis searches for terms and/or other content that indicate a future action to be performed and a corresponding action date by which to perform the action. In response to detecting such terms and/or other content, the technique further includes creating metadata indicative of the action and a date for performance of that action and storing such metadata in a database. The technique further includes querying the database, e.g., prior to or upon the action date, and creating a modified version of the document to implement the detected action.

Advantageously, the improved technique improves user experience and reduces processing and computational demands on server resources. Reducing server demands allows fewer and/or less powerful servers to be deployed, reducing hardware costs as well as costs for power and maintenance.

Certain embodiments are directed to a method that includes identifying, based at least in part on a range of dates, an electronic document from a database and obtaining, from the database, metadata indicative of the electronic document. The metadata includes a date and an identifier of an entity of the electronic document. Prior to or upon an occurrence of the date, the method further includes (i) obtaining the electronic document from a service provider, (ii) generating a modified version of the electronic document, and (iii) transmitting a link to the modified version to the entity. Based on activation of the link, the method still further includes providing the modified version of the document for signature.

In some examples, the method further includes modifying the modified version of the electronic document based on changes made by the entity.

In some examples, the metadata is further indicative of one or more identifiers of parties to the electronic document, and the method further includes, based on the activation of the link, sending respective requests for signing the modified version of the document to the parties.

In some examples, generating the modified version of the document includes changing the date on the electronic document to a revised date that is later than the date.

In some examples, the method further includes receiving a second document, identifying an action date specified by the second document, and determining, based on text extracted from the second document, an action specified by the second document in connection with the action date. The method further includes sending an electronic message to an entity of the second document, the electronic message requesting confirmation that the action specified by the second document is due for performance by the action date, and in response to confirmation from the entity of the second document, storing second metadata in the database, the second metadata specifying, in connection with an identifier of the second document, an indicator of the action date and an indicator of the action.

In some examples, determining the specified action includes performing keyword analysis on the text extracted from the second document.

In some examples, determining the specified action includes performing natural language processing on the text extracted from the second document.

In some examples, performing the natural language processing includes providing the extracted text to a machine-learning model trained to detect specified actions and associated action dates.

In some examples, the method further includes training the machine-learning model at least in part using previously-executed documents stored by the service provider.

In some examples, training the machine-learning model includes operating the machine-learning model on a first previous document stored by the service provider to generate a prediction that the first previous document is renewable and an associated renewal date, and providing positive feedback for the prediction made by the machine-learning model responsive to determining that a second previous document stored by the service provider is a renewal of the first previous document.

In some examples, the method further includes matching the first previous document to the second previous document is based on at least one of: (i) the first previous document and the second previous document sharing a common owner, (ii) the first previous document and the second previous document sharing a common set of parties, (iii) the first previous document and the second previous document having been generated from a common user account, or (iv) the first previous document and the second previous document having been generated from a common document template.

Other embodiments are directed to a method that includes: determining, by a computing device, a time at which to update an electronic document, the determination being made based on content of the document; retrieving, by the computing device, the document from a database at or prior to the determination of the time; extracting, by the computing device, data from the document, the data being indicative of at least one change to be made to the document; determining, by the computing device, at least one modification to the electronic document based on the data extracted; and modifying, by the computing device, the electronic document to include the at least one modification by addition or deletion of content to or from the electronic document at or prior to the determined time.

Still other embodiments are directed to a computerized apparatus constructed and arranged to perform any of the methods described above. Further embodiments are directed to a computer program product. The computer program product stores instructions which, when executed on control circuitry of a server, cause the server to perform any of the methods described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of a server in accordance with certain embodiments.

FIG. 2 is a schematic block diagram of a cloud computing environment in which various aspects of the disclosure may be implemented.

FIG. 3 is a block diagram of an example computing environment in which embodiments of the improved technique can be practiced.

FIG. 4 is a block diagram of example metadata that may be provided in the environment of FIG. 3.

FIG. 5 is a block diagram of an example document action manager that may be provided in the environment of FIG. 3.

FIG. 6 is a flowchart showing an example method of receiving a document for processing in the environment of FIG. 3.

FIG. 7 is a flowchart showing an example method of generating a modified version of a document.

FIG. 8 is a flowchart showing example method of processing a document;

FIG. 9 is a sequence diagram showing an example sequence of activities related to receiving and analyzing a document.

### DETAILED DESCRIPTION

Embodiments of the improved technique will now be described. One should appreciate that such embodiments are provided by way of example to illustrate certain features and principles but are not intended to be limiting.

An improved technique for document management involves performing a text-based analysis of a document submitted for signature and/or storage. The text-based analysis searches for terms and/or other content that indicate a future action to be performed and a corresponding action date by which to perform the action. In response to detecting such terms and/or other content, the technique further includes creating metadata indicative of the action and associated action date and storing such metadata in a database. The technique further includes querying the database, e.g., prior to or upon the action date, and creating a modified version of the document to implement the detected action.

### Example Computing Environment:

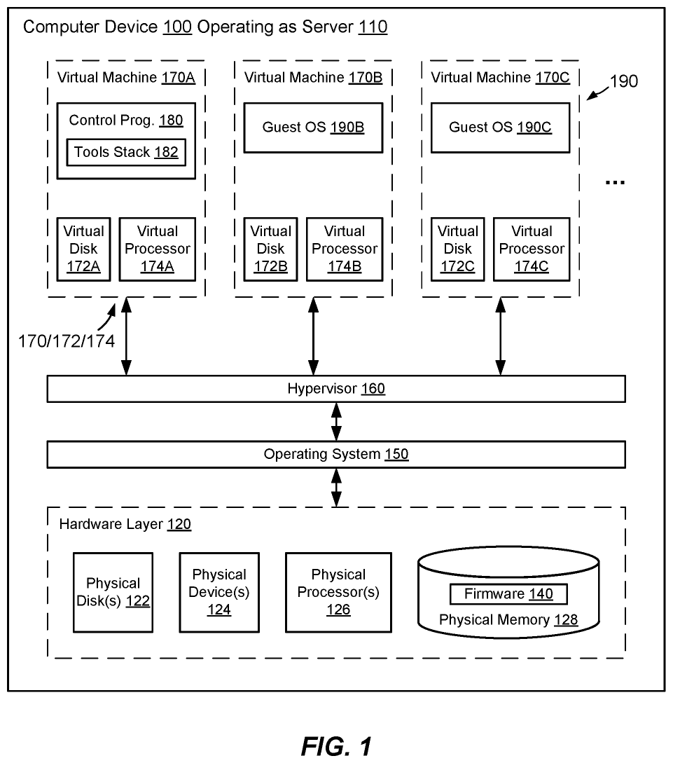

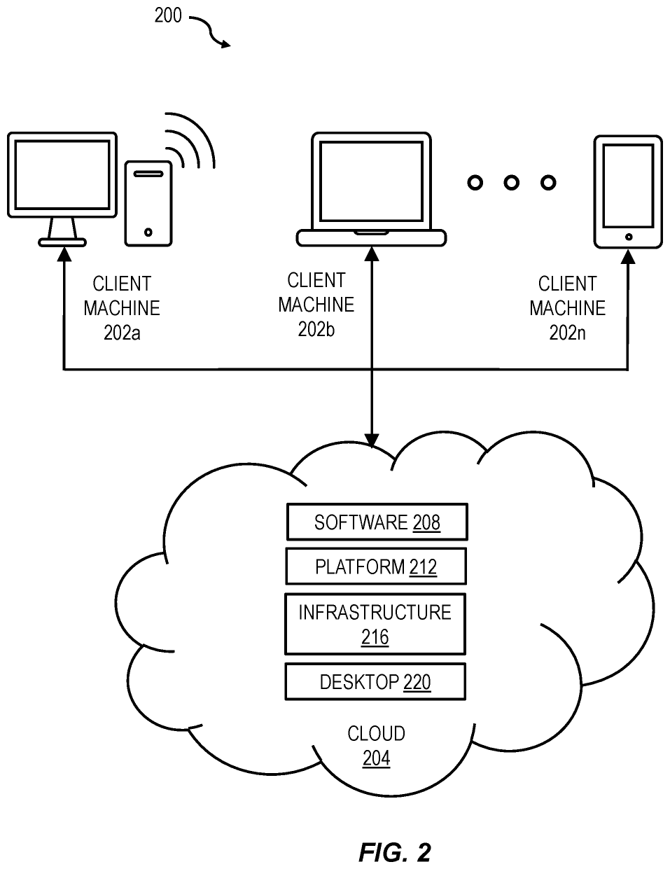

FIGS. 1 and 2 show an example environment in which certain embodiments may be practiced. The depicted environment is provided for purposes of illustration and is not intended to be limiting.

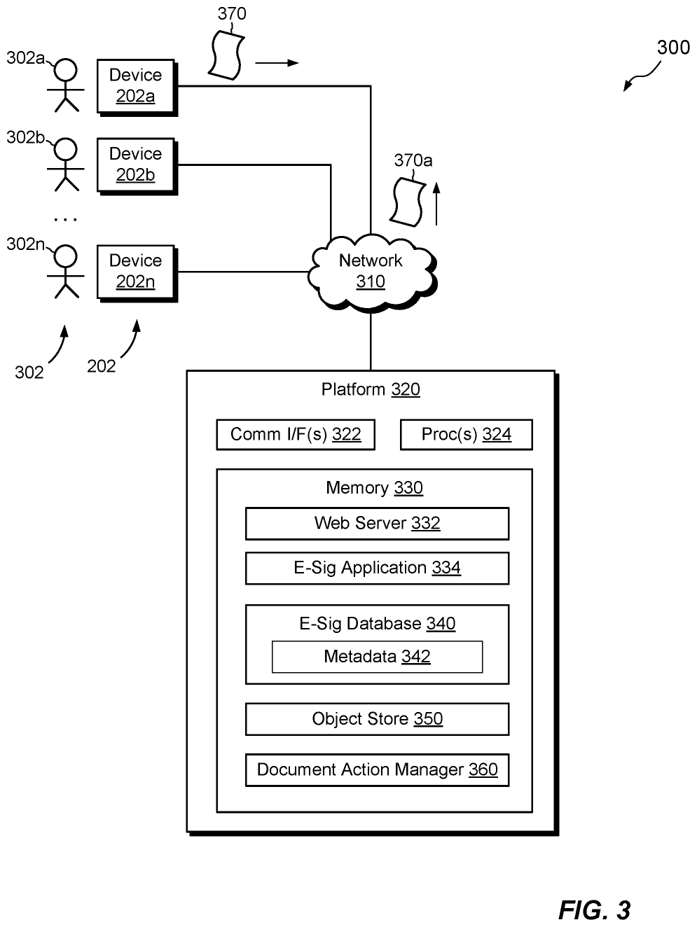

FIG. 1 shows a computer device 100 operating as a server (e.g., virtualization server) 110 which is suitable for providing document preparation and management services within the computing environment in accordance with certain embodiments. It should be understood that FIG. 1 shows a high-level architecture of an illustrative desktop virtualization system. Such a system is suitable for use as at least a portion of the platform 320 (FIG. 3).

As shown in FIG. 1, the desktop virtualization system may be a single-server or multi-server system, or a cloud system, including at least one computer device 100 operating as a virtualization server 110 configured to provide virtual desktops and/or virtual applications to one or more client access devices. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Individual instances of the operating system may be physical (e.g., one operating system per physical device) or virtual (e.g., many instances of an OS running on a single physical device). Applications may be executed on a local device, or executed on a remotely located device (e.g., remoted).

The computer device 100 may be configured as a virtualization server in a virtualization environment, for example, a single-server, multi-server, or cloud computing environment. Virtualization server 110 illustrated in FIG. 1 may be deployed as and/or implemented by one or more embodiments of the platform 320 or by other known computing devices. Included in virtualization server 110 is hardware layer 120 that may include one or more physical disks 122, one or more physical devices 124, one or more physical processors 126, and one or more physical memories 128. In some embodiments, firmware 140 may be stored within a memory element in physical memory 128 and be executed by one or more of physical processors 126. Virtualization server 110 may further include operating system 150 that may be stored in a memory element in physical memory 128 and executed by one or more of physical processors 126. Still further, hypervisor 160 may be stored in a memory element in physical memory 128 and be executed by one or more of physical processors 126. Presence of operating system 150 may be optional such as in a case where the hypervisor 160 is a Type A hypervisor.

Executing on one or more of physical processors 126 may be one or more virtual machines 170A, 170B, 170C, . . . (generally, VMs 170). The VMs 170A, 170B, 170C, . . . include respective virtual disks 172A, 172B, 172C, . . . (generally, virtual disks 172) and respective virtual processors 174A, 174B, 174C, . . . (generally, virtual processors 174). In some embodiments, the first VM 170A may execute, using virtual processor 174A, control program 180 that includes tools stack 182. Control program 180 may be referred to as a control virtual machine, Domain 0, Dom0, or other virtual machine used for system administration and/or control. In some embodiments, one or more VMs 170B, 170C, . . . may execute, using their respective virtual processors 174B, 174C, . . . , guest operating systems 190B, 190C, . . . (generally, guest operating systems 190).

Physical devices 124 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 110. Physical memory 128 in hardware layer 120 may include any type of memory. Physical memory 128 may store data, and in some embodiments may store one or more programs, or set of executable instructions. FIG. 1 illustrates an embodiment where firmware 140 is stored within physical memory 128 of virtualization server 110. Programs or executable instructions stored in physical memory 128 may be executed by the one or more processors 126 of virtualization server 110.

Virtualization server 110 may also include hypervisor 160. In some embodiments, hypervisor 160 may be a program executed by processors 126 on virtualization server 110 to create and manage any number of virtual machines 170. Hypervisor 160 may be referred to as a virtual machine monitor, or platform virtualization software. In some embodiments, hypervisor 160 may be any combination of executable instructions and hardware that monitors virtual machines 170 executing on a computing machine. Hypervisor 160 may be a Type 2 hypervisor, where the hypervisor executes within operating system 150 executing on virtualization server 110. Virtual machines may then execute at a layer above hypervisor 160. In some embodiments, the Type 2 hypervisor may execute within the context of a user's operating system such that the Type 2 hypervisor interacts with the user's operating system. In other embodiments, one or more virtualization servers 110 in a virtualization environment may instead include a Type 1 hypervisor (not shown). A Type 1 hypervisor may execute on virtualization server 110 by directly accessing the hardware and resources within hardware layer 110. That is, while Type 2 hypervisor 160 accesses system resources through host operating system 150, as shown, a Type 1 hypervisor may directly access all system resources without host operating system 110. A Type 1 hypervisor may execute directly on one or more physical processors 126 of virtualization server 110, and may include program data stored in physical memory 128.

Hypervisor 150, in some embodiments, may provide virtual resources to guest operating systems 190 or control programs 180 executing on virtual machines 170 in any manner that simulates operating systems 190 or control programs 180 having direct access to system resources. System resources can include, but are not limited to, physical devices 122, physical disks 124, physical processors 126, physical memory 128, and any other component included in hardware layer 120 of virtualization server 110. Hypervisor 160 may be used to emulate virtual hardware, partition physical hardware, virtualize physical hardware, and/or execute virtual machines that provide access to computing environments. In still other embodiments, hypervisor 160 may control processor scheduling and memory partitioning for virtual machines 170 executing on virtualization server 110. Examples of hypervisor 160 may include those manufactured by VMWare, Inc., of Palo Alto, Calif.; Xen Project® hypervisor, an open-source product whose development is overseen by the open source XenProject.org community; Hyper-V®, Virtual Server®, and Virtual PC® hypervisors provided by Microsoft Corporation of Redmond, Wash.; or others. In some embodiments, virtualization server 110 may execute hypervisor 160 that creates a virtual machine platform on which guest operating systems 190 may execute. In these embodiments, virtualization server 110 may be referred to as a host server. An example of such a virtualization server is Citrix Hypervisor® provided by Citrix Systems, Inc., of Fort Lauderdale, Fla.

Hypervisor 160 may create one or more virtual machines 170 in which guest operating systems 190 execute. In some embodiments, hypervisor 160 may load a virtual machine image to create virtual machine 170. The virtual machine image may refer to a collection of data, states, instructions, etc. that make up an instance of a virtual machine. In other embodiments, hypervisor 160 may execute guest operating system 190 within virtual machine 170. In still other embodiments, virtual machine 170 may execute guest operating system 190.

In addition to creating virtual machines 170, hypervisor 160 may control the execution of at least one virtual machine 170. In other embodiments, hypervisor 160 may present at least one virtual machine 170 with an abstraction of at least one hardware resource provided by virtualization server 110 (e.g., any hardware resource available within hardware layer 110). In other embodiments, hypervisor 160 may control the manner in which virtual machines 170 access physical processors 126 available in virtualization server 110. Controlling access to physical processors 126 may include determining whether virtual machine 170 should have access to processor 126, and how physical processor capabilities are presented to virtual machine 170.

As shown in FIG. 1, virtualization server 110 may host or execute one or more virtual machines 170. Virtual machine 170 may be a set of executable instructions and/or user data that, when executed by processor 126, may imitate the operation of a physical computer such that virtual machine 170 can execute programs and processes much like a physical computing device. While FIG. 1 illustrates an embodiment where virtualization server 110 hosts three virtual machines 170, in other embodiments virtualization server 110 may host any number of virtual machines 170. Hypervisor 160, in some embodiments, may provide each virtual machine 170 with a unique virtual view of the physical hardware, including memory 128, processor 126, and other system resources 122, 124 available to that virtual machine 170. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 160 may create one or more unsecure virtual machines 170 and one or more secure virtual machines 170. Unsecure virtual machines 170 may be prevented from accessing resources, hardware, memory locations, and programs that secure virtual machines 170 may be permitted to access. In other embodiments, hypervisor 110 may provide each virtual machine 170 with a substantially similar virtual view of the physical hardware, memory, processor, and other system resources available to virtual machines 170.

Each virtual machine 170 may include a respective virtual disk 172 and respective virtual processor 174. Virtual disk 172, in some embodiments, may be a virtualized view of one or more physical disks 122 of virtualization server 110, or a portion of one or more physical disks 122 of virtualization server 110. The virtualized view of physical disks 122 may be generated, provided, and managed by hypervisor 160. In some embodiments, hypervisor 160 may provide each virtual machine 170 with a unique view of physical disks 122. Thus, in these embodiments, particular virtual disk 122 included in each virtual machine 170 may be unique when compared with other virtual disks 172.

Virtual processor 174 may be a virtualized view of one or more physical processors 126 of virtualization server 110. In some embodiments, the virtualized view of physical processors 126 may be generated, provided, and managed by hypervisor 160. In some embodiments, virtual processor 174 may have substantially all of the same characteristics of at least one physical processor 126. In other embodiments, virtual processor 174 may provide a modified view of physical processors 126 such that at least some of the characteristics of virtual processor 174 are different from the characteristics of the corresponding physical processor 126.

It should be understood that the computer device 100 operating as the virtualization server 110 may be configured to provide electronic signature services as a cloud service. Along these lines, various users involved in preparing and/or electronically signing a document are able to access the cloud service.

Referring now to FIG. 2, a cloud computing environment 200 is depicted, which may also be referred to as a cloud environment, cloud computing or cloud network. The cloud computing environment 200 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 200, one or more clients (or user devices) 202a-202n (such as those described above) are in communication with a cloud network 204. The cloud network 204 may include back-end platforms, e.g., servers, storage, server farms or data centers. The users or clients 202a-202n can correspond to a single organization/tenant or multiple organizations/tenants. More particularly, in one example implementation the cloud computing environment 200 may provide a private cloud serving a single organization (e.g., enterprise cloud). In another example, the cloud computing environment 200 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 200 may provide a hybrid cloud that is a combination of a public cloud and a private cloud. Public clouds may include public servers that are maintained by third parties to the clients 202a-202n or the enterprise/tenant. The servers may be located off-site in remote geographical locations or otherwise.

The cloud computing environment 200 can provide resource pooling to serve multiple users via clients 202a-202n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 200 can provide on-demand self-service to unilaterally provision computing capabilities (e.g., server time, network storage) across a network for multiple clients 202a-202n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 200 can provide an elasticity to dynamically scale out or scale in response to different demands from one or more clients 202. In some embodiments, the cloud computing environment 200 can include or provide monitoring services to monitor, control and/or generate reports corresponding to the provided shared services and resources.

In some embodiments, the cloud computing environment 200 may provide cloud-based delivery of different types of cloud computing services, such as Software as a service (SaaS) 208, Platform as a Service (PaaS) 212, Infrastructure as a Service (IaaS) 216, and Desktop as a Service (DaaS) 220, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

### Computing Environment:

Example aspects of a computing environment 300 will now be described with reference to FIG. 3. One should appreciate that environment 300 may be realized in the computing environment shown in FIGS. 1 and 2, for example, although this is not required.

As shown in FIG. 3, multiple user devices 202 (e.g., 202a-200n) of respective users 302 (e.g., 302a-302n) connect to a computing platform (e.g., an e-signature platform) 320 over a network 310. The user devices 202 may include any type or types of computing device capable of connecting to the network 310 and running software, such as desktop computers, laptop computers, tablet computers, smart phones, PDAs (personal data assistants), or the like. The network 310 may be any type of network or combination of networks, such as a local area network (LAN), a wide area network (WAN), the Internet, and/or some other type of network or combination of networks, for example.

The platform 320 includes one or more communication interfaces 322, a set of processors 324, and memory 330. The communication interfaces 322 include, for example, network interface adapters for converting electronic and/or optical signals received over the network 310 to electronic form for use by the platform 320. The set of processors 324 includes one or more processing chips and/or assemblies, such as numerous multi-core CPUs (central processing units). The memory 330 includes both volatile memory, e.g., RAM (Random Access Memory), and non-volatile memory, such as one or more ROMs (Read-Only Memories), disk drives, solid state drives, and the like. The set of processors 324 and the memory 330 together form control circuitry, which is constructed and arranged to carry out various methods and functions as described herein. Also, the memory 330 includes a variety of software constructs realized in the form of executable instructions. When the executable instructions are run by the set of processors 324, the set of processors 324 carry out the operations of the software constructs. Although certain software constructs are specifically shown and described, it is understood that the memory 330 typically includes many other software components, which are not shown, such as an operating system, various applications, processes, and daemons.

As further shown in FIG. 1, the memory 330 “includes,” i.e., realizes by execution of software instructions, a web server 332 and an e-signature application 334. The e-signature application 334 may be provided as a web application, which may be hosted to user devices 202 via the web server 332. The memory 330 further includes a database 340, an object store 350, and a document action manager 360. The database 340 is configured to store metadata 342 related to document management and storage. The metadata 342 may include document-specific metadata, as well as metadata for entities (e.g., owners of documents), parties, templates, and the like. The object store 350 is configured to store documents, such as contracts and other documents uploaded to the computing platform 320 by users 302. The document action manager 360 is configured to perform numerous activities related to analyzing documents for actions and action dates, confirming analysis results with entities, and implementing detected actions, e.g., by generating modified documents.

The platform 320 may be realized using any number of physical computers, including just a single computer (as shown). Some of the depicted components may be provided by a third party. For example, the object store 350 may be implemented using Amazon Web Services or some other cloud-based service provider. Such computers and components are all considered herein to be part of the e-signature platform 320, which may also be referred to herein as the “server.”

In example operation, a user 302, such as user 302a, creates a document 370 for signature by one or more parties. The document 370 may be entirely original, i.e., created entirely from scratch, or it may be generated from a template, i.e., a document skeleton that includes standard content as well as fields for receiving custom data. The custom data may specify particular parties, i.e., persons signing the document, contact information, dates, and other information, such as document-specific terms.

In an example, the user 302a opens a browser or app on the user's device 202a and navigates to the computing platform 320, e.g., to a landing page of the e-signature application 334 hosted by the web server 332. The user 302a may then specify email or SMS (short message service) addresses of the party or parties to the document and may upload the document 370 to the platform 320. The user 302a may then have the option to create data entry fields, which may include signature fields, date fields, and the like, and may submit the document for signature. In response to the user's submission, the platform 320 may send links by email or SMS, inviting the party or parties to review and sign the document. Once the parties have done so, the document may be considered complete, and the platform 320 may store the document, e.g., in the object store 350.

In accordance with improvements hereof, the platform 320 analyzes the document 370 to determine whether the document indicates any future action and associated action date. For example, the platform 320 may invoke the document action manager 360, which may perform OCR (optical character recognition) on the executed document, search for keywords that indicate future actions in the document text, and/or apply the document text to an NLP (natural language processing) engine trained to detect future actions and associated action dates. The result of such an analysis may be a determination of whether the document 370 indicates a future action (e.g., yes or no) and, if yes, the associated action date associated with the action.

In a particular example, the action to be determined is a renewal of the document, and the date of the action is an expiration date or renewal date of the document. In an example, the document action manager 360 may determine that the document is renewable based on keywords (e.g., the presence of a word having the root “renew” or the root “expir”) or by a pattern of text in the document that suggests a provision for renewal or expiration of the document. Also in an example, the document action manager 360 may determine that a document is renewable based on a prior pattern of renewals. For example, if a particular document has already been renewed on a particular month over a course of preceding years, the document action manager 360 may conclude that the document is renewable based on the prior history of renewals. The renewal date may be determined based on a field name associated with a date which appears in the document (e.g., a field name called “Renewal Date”), based on proximity to a word or words having any of the above-mentioned word roots, or based on other patterns in the document, for example.

Once the document action manager 360 has determined that the document 370 specifies an action, such as “renewable,” and an action date, such as an associated renewal date, the document action manager 360 may contact an entity of the document 370, such as a person associated with the document, to confirm the determination. For example, the document action manager 360 may contact the entity by sending an email or text message requesting confirmation. The email may identify the determined action and action date and request that the entity confirm that the indicated action and date are proper. The entity is typically the owner of the document, such as the user 302a, or some other responsible person known to the platform 320. The entity may confirm the information by clicking a link in the email or text message. Clicking the link by the entity causes the corresponding user device 202a to send a message to the platform 320 indicating that the information is confirmed. In some examples, the entity may also modify the information. For example, the entity may follow a second link in the email or text message to change an action date to something different from the one indicated. The entity may also disconfirm the specified information, e.g., by clicking a third link in the email or text message indicating that the information is incorrect (e.g., that the document is not renewable). In some examples, the email or text message includes only a single link, and clicking the link by the entity opens a page that allows the entity either to confirm, disconfirm, or modify the information.

Once the platform 320 receives confirmation from the entity, the e-signature platform 320 may update the metadata 342 in the database 340, e.g., by storing an indication that the document 370 is renewable (e.g., by setting a flag) and by storing an indication of the associated action date as the determined renewal date. Such indications may be provided in a database record provided for the document 370 or in some other way. Preferably, the indications of action (e.g., renewability) and action date (e.g., renewal date) are stored in queryable elements of the database 340, such that the records that contain them may be returned at a later time in response to queries of documents based on the action date.

One should appreciate that the above-described operations of the document action manager 360 may be scheduled at any convenient time. There is no need for the operations to be performed in real time, e.g., while the entity is logged on, uploading and configuring the document. Thus, the analysis of the document 370 may be asynchronous with the entity's activities and indeed may proceed in the background, ideally at times when the platform 320 is under light load.

In accordance with further improvements hereof, the platform 320 may query the database 334 to identify documents with upcoming action dates. For example, the platform 320 may query the database 334 automatically on some schedule, such as weekly, monthly, or at any other suitable time interval. Such queries may specify ranges of upcoming action dates, such as those which fall within the upcoming week, month, or any other suitable date range.

Based on query results, the platform 320 may perform activities in furtherance of the specified actions. Assume, for example, that a query returns the document 370, e.g., based on the e-signature database 340 storing a renewal date for that document which falls within the query's specified date range. In such a case, the platform 320 may direct the document action manager 360 to generate a modified version 370a of the document 370. In an example, the modified version 370a is similar to the document 370, except that it is unexecuted and contains an updated action date. For instance, if the original renewal date of document 370 was Nov. 14, 2021, the document action manager 360 may provide the document with a new renewal date, such as Nov. 14, 2022.

When updating action dates, the document action manager 360 may increment action dates by one year, by default. This is merely an example, however. For instance, analysis of the document may indicate a different update interval, which may be used in place of the one-year default. In some examples, the e-signature database 340 includes a field or other data element for storing update intervals on a per-document basis.

Once the updated document 370a has been generated, the platform 320 may send a message (e.g., email or text) to the entity for approval. The message contains a link to the updated document 370a. For example, the entity may receive such a message and click the link. Clicking the link has the effect of downloading the document 370a to the entity's device, where the entity can review the document 370a and confirm, disconfirm, or modify the document. In some examples, modifications may involve changing field values, making text-based additions, or deleting portions of the document 370a that are no longer needed.

Assuming that the entity confirms the modified document, the computing platform 320 may process the document 370a for signature. For example, the platform 320 sends a message (e.g., email or text) to the identified party or parties. The message contains a link to the modified document 370a. The party or parties may review the document 370a and sign the document in the usual manner.

In the described arrangement, the platform 320 generates modified documents 370a automatically and typically in the background, i.e., outside the context of user sessions and out of band with user requests to create new documents. As it can create modified documents in the background, the platform 320 is less burdened with real-time user activities and can operate more efficiently. For example, ingesting a new document may involve many actions on the part of the platform 320, such as creating a new session for the user, uploading the document from the user, converting the document from text to graphical format, receiving field values associated with the document, storing the field values in one or more databases, and storing the document itself. Such activities may be avoided or more conveniently scheduled, e.g., to coincide with periods of low activity, when new documents or versions thereof are created automatically by the platform 320. The improved arrangement also benefits entities, as they are not required to generate and upload modified documents themselves. Entities are also prompted to renew their documents on time, thus avoiding potentially costly lapses in document coverage.

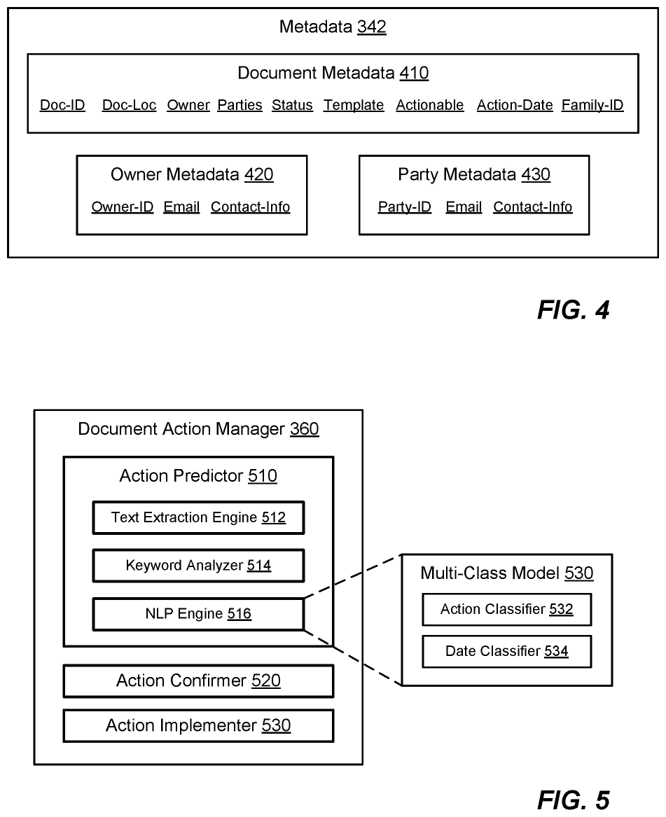

FIG. 4 shows example metadata 342 of the database 340 in additional detail. Here, such metadata 342 is seen to include metadata 410 about a document, metadata 420 indicative of an owner, and metadata 430 about other parties to or otherwise related to the document. One should appreciate that different or other metadata may be stored from that shown and that the illustration merely provides an example.

Metadata 410 may be provided on a per-document basis, for example, where records of the metadata 410 correspond to respective documents, like documents 370 and 370a. Example data elements or fields of the document metadata 410 may include the following:
Doc-ID. A unique identifier of a document in the e-signature platform 320.
Doc-Loc. A storage location of the document, such as an address of the document in the object store 350.
Owner. A designated owner of the document (also referred to herein as an “entity”).
Parties. One or more parties to the document. Parties may be identified by respective Party-IDs.
Status. A status of the document, such as pending, executed, or expired.
Template. A skeleton form from which the respective document was created. Could be user-generated or a standard form provided by the e-signature platform 320.
Actionable. An indicator of whether the document is actionable, e.g., renewable or subject to some other action. May be provided as a flag or other Boolean value.
Action-Date. An indicator of a date by which the respective action is due, such as a renewal date or an expiration date.
Family-ID. An identifier of a document family to which the document belongs. A “family” as used herein refers to a base document and any documents created from the base document according to actions, such as renewals. Multiple renewals may share the same Family-ID, and the existence of multiple renewals may itself contribute to a determination that a document is renewable.

As further shown in FIG. 4, owner metadata 420 may include the following data elements or fields, which may be provided on a per-owner basis, for example:
Owner-ID. A unique identifier of an owner. May be based on the owner's name and/or on automatically-generated content.
Email. An email address of the owner.
Contact-Info. A name and other contact information of the owner.

Similar information may be provided for parties named in documents. For example, party metadata 430 may include the following:
Party-ID. A unique identifier of a party. May be based on the party's name and/or on automatically-generated content.
Email. An email address of the party.
Contact-Info. A name and other contact information of the party.

Preferably, the metadata 410, 420, and 430 are queryable, such that records of the respective metadata may be returned in response to queries that specify any of the data elements or fields thereof in query criteria. For example, actionable (e.g., renewable) documents may be identified by querying the document metadata 410 for all documents for which “Actionable =True.” Likewise, documents due for renewal during the next month may be found by querying the document metadata 410 for all documents for which “(Action-Date>=Now) AND (Action-Date<(Now+one month). It is thus evident that the metadata 342 of the database 340 may be used as a basis for identifying renewable documents and documents due for renewal within any specified time interval.

FIG. 5 shows example features of the document action manager 360 in additional detail. Here, the document action manager 360 is seen to have three main components: an action predictor 510, an action confirmer 520, and an action implementor 530. In a non-limiting example, action predictor 510, action confirmer 520, and action implementor 530 are realized in software constructs that run in the memory 330 of the platform 320 and are run by the set of processors 324. Action predictor 510 is configured to determine, i.e., by prediction, whether a particular document uploaded to the e-signature platform 320 is actionable (e.g., renewable), as well as an associated action date, such as a renewal date. Action confirmer 520 is configured to confirm or disconfirm predictions made by action predictor 510, e.g., by contacting entities (e.g., by email or text) to obtain explicit confirmation that analyzed documents are renewable and their associated renewal dates. Action implementer 530 is configured to implement actions, such as by updating metadata 142 in the database 340 to reflect renewability and renewal dates, by generating modified documents (e.g., to contain new renewal dates), and by performing any other needed activities in furtherance of indicated actions.

As further shown in FIG. 5, action predictor 510 may include a text extraction engine 512, a keyword analyzer 514, and an NLP (natural language processing) engine 516. These features are described in further detail below.

Text extraction engine 512 is configured to extract text from a document, such as by performing OCR (optical character recognition) on the document. For example, the document may be received as a PDF (portable document format) file, a TIFF (tagged image file format) file, a JPEG (Joint Photographic Experts Group) file, a PNG (Portable Network Graphics) file, a GIF (Graphic Interchange Format) file, or some other type of file in a graphical image format. The text extraction engine 512 converts pixel-based, graphical representations of text characters in the file to corresponding text-based data, such as ASCII or ANSI data, or data in some other textual format. Output of the text extraction engine 512 is typically a text file or a text stream. The output file or stream preferably presents text in the same order in which the graphical depictions of text are presented in the original file.

Keyword analyzer 514 searches the text file or stream for specified keywords that indicate a document action (e.g., that the document is renewable). The term “keywords” is intended to be broadly construed to include single words as well as phrases and dates. Examples of keywords may include any of the following:
Words based on the root “renew,” such as renew, renewable, renewal, renewed, or the like.
Words based on the root “expir,” such as expire, expires, expired, expiration, or the like.
Words based on the root “term,” such as term, terminate, termination, or the like.
Any other words or phrases suggestive of document renewal, expiration, or termination.
Text that indicates dates, such as “November 1, 2021” or “11-1-2021.”

NLP engine 516 employs natural language processing for the purpose of determining whether a document is actionable and an associated action date. In an example, the NLP engine 516 includes a multi-class model 530 trained for this purpose. For example, multi-class model 530 may include an action classifier 532 and a date classifier 534, which are trained to determine whether a document is renewable and an associated renewal date, for example. Multi-class models are commonly provided in NLP engines, with one suitable example being Amazon Comprehend.

In an example, the multi-class model 530 is trained using documents received by the platform 320. For example, the multi-class model 530 may receive the text of documents and make corresponding predictions as to renewability and renewal date. The action confirmer 520 may send such predictions to entities, which may confirm the predicted renewability and renewal dates or disconfirm them. Any determination of renewability or renewal date which is confirmed may be provided to the model 530 as positive feedback, and any determination of the model 530 which is disconfirmed may be provided to the model 530 as negative feedback. Based on the positive and negative feedback, the multi-class model 530 can adjust its settings, e.g., by updating weights between nodes of one or more neural networks, converging over time on better and better predictions.

In some examples, the multi-class model 530 may be trained based on a corpus of previously stored documents. For example, the object store 350 may contain millions of documents and at least some of these documents may provide a training set for the multi-class model 530. Training may be supervised or unsupervised.

To train the multi-class model 530 based on previously-stored documents, the e-signature platform 320 may analyze previous documents in the object store 350 to identify clear examples of renewals. A renewal may be identified, for example, based on a later document matching an earlier document in terms of the same entity, parties, template, or account, or based on other similarities, such as similar document text. A renewal may further be confirmed based on document terms and language (e.g., keywords). Determinations of renewals among previous documents may be made automatically, for example. Once clear examples of renewals have been identified, the platform 320 may direct the multi-class model 530 to generate predictions of renewability and renewal dates using the earlier documents. If the model 530 generates a correct prediction, the model receives positive feedback. Otherwise, the model may receive no feedback or negative feedback. The model 530 may also be trained based on documents that clearly are not renewable. In such cases, positive and/or negative feedback may be given based on whether the model 530 correctly predicts that a document is not renewable.

In an example, the action predictor 510 uses a layered approach in determining whether documents are actionable (e.g., renewable) and action dates (e.g., renewal dates). If one layer fails to indicate clearly whether a document is actionable, one or more subsequent layers may be tried. For example, the action predictor 510 first applies keyword analysis (e.g., as a first layer) to determine whether a document is renewable. If keyword analysis produces a clear result of renewability, then the document may be deemed renewable without requiring the use of the NLP engine 516. The NLP engine 516 may thus be regarded as a second-layer approach in case keyword analysis fails to provide a clear result. Results of the NLP Engine 516 may themselves be subject to confirmation by entities (e.g., as a third-layer approach).

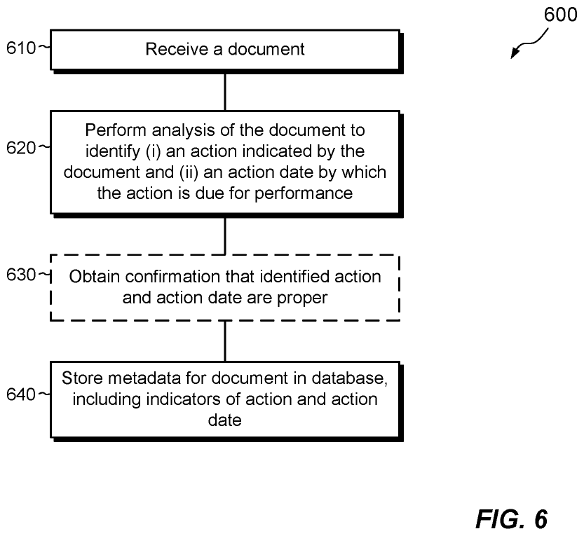

FIGS. 6-8 show example methods 600, 700, and 800 that may be carried out in connection with the environment 300. The methods 600, 700, and 800 are typically performed, for example, by the software constructs described in connection with FIG. 3, which reside in the memory 330 of the computing platform 320 and are run by the set of processors 324. The various acts of methods 600, 700, and 800 may be ordered in any suitable way. Accordingly, embodiments may be constructed in which acts are performed in orders different from those illustrated, which may include performing some acts simultaneously.

FIG. 6 shows an example method 600 of receiving a document into the computing platform 320 (e.g., a server or other computing device). For example, method 600 is performed by the platform 320 in response to a user logging onto the platform 320 to provide a new document 370 for signature.

At 610, the user 302 uploads the document 370, e.g., by dragging and dropping a document into a region of a web page downloaded from the e-signature platform 320 to the user's device 202. At this time, the user 302 may also specify email addresses of parties to the document and may specify any required data-entry fields.

At 620, which may be performed at a later time, the platform 320 performs an analysis of the uploaded document 370 to identify an action indicated by the document, such as a renewal, and a corresponding action date, such as a renewal date, by which the specified action is due to be performed. Act 620 may involve operation of the action predictor 510, described in connection with FIG. 5, and may be performed in the background, i.e., out of band with the user sessions during which the documents are uploaded.

At 630, the platform 320 obtains confirmation that the identified action and action date are proper. For example, action confirmer 520 (FIG. 5) messages an entity of the document, such as the owner, requesting confirmation that the document is indeed renewable and that the indicated renewal date is proper. In an example, the message includes a link that the user may click to confirm renewability and renewal date. One should appreciate that act 630 may be optional in some embodiments, as the platform 320 may also proceed without confirmation.

At 640, the platform 320 creates and stores metadata for the analyzed document in the database 340. For example, the platform 320 creates a new record for the document 370 in the document metadata 410. The new record may include an indicator of the action, e.g., a value of “yes” in the “actionable” field, and an associated action-date.

The acts of method 600 are preferably completed shortly after the user has uploaded the document, such as over the course of the following days. In this manner, the computing platform 320 is not burdened by having to perform document analysis in real time. No particular timing is required, however. Also, once the acts of method 600 are complete, the platform 320 is able to query the document metadata 410 based on action-date to identify any documents with upcoming actions, such as renewals.

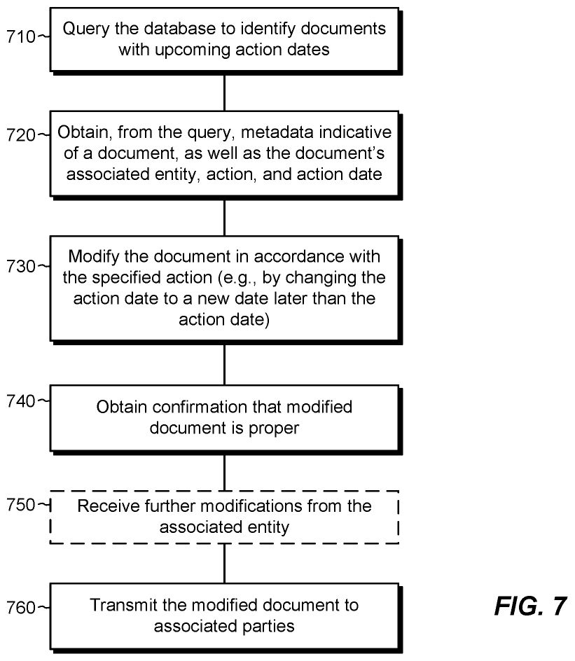

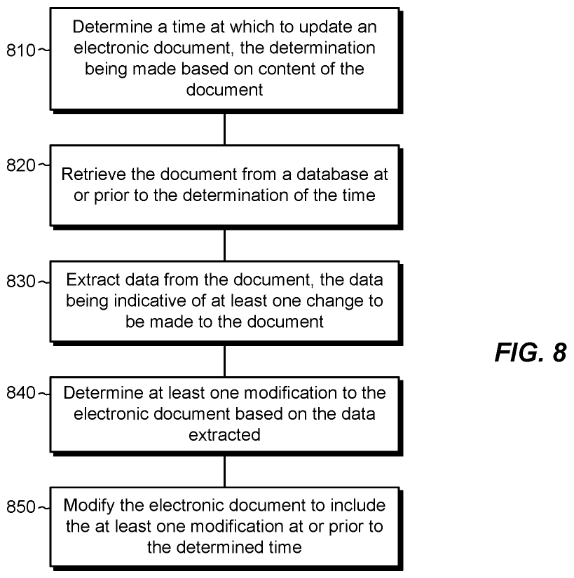

FIG. 7 shows an example method 700 of generating a modified version of a document prior to a specified action date. Method 700 may be performed at any time after the acts of method 600 are completed.

At 710, the computing platform 320 queries the database 342 to identify documents with upcoming action dates. For example, the platform 320 runs a query of the document metadata 410 that selects documents for which “actionable” is true and “action-date” falls within a specified date range, such as any time over the next month.

At 720, the platform 320 obtains query results as metadata, such as Doc-ID, of a document 370 that meets the query criteria. The query may return additional metadata, such as the associated entity (e.g., owner), action, action date, and email or SMS addresses of parties to the document.

At 730, the platform 320 modifies the document 370 in accordance with the specified action. For example, if the action is to renew the document, the e-signature platform 320 may provide a new version 370a of the document that specifies a new renewal date. Other content of the new version 370a may be similar to that of the original.

At 740, the platform 320 obtains confirmation that the modified document is proper. For example, the computing platform 320 sends a message to the entity. The message (e.g., email or SMS) may contain a link to the modified document 370a. The entity may receive the message and view the modified document 370a by activating the link. The entity may then confirm that the modified version is proper. Alternatively, the entity may disconfirm the modified document.

Optionally, at 750, the platform 320 receives further modifications of the document 370a made by the entity. For example, upon viewing the modified document 370a at step 740, the entity may make further changes to the document, such as by changing field values, adding text, or removing text.

At 760, upon receiving confirmation that the modified (or further modified) document is proper, the platform 320 transmits the modified document 370a (or a link thereto) to the associated party or parties, e.g., those identified in the “Parties” field of the document metadata 410. Such parties may then execute the document 370a. Once all parties have executed the document, the platform 320 may store the document 370a in the object store 350. At or about this time, the e-signature platform 320 may create a new record in the document metadata 410 for the modified document 370a. The new record may be accorded a new Doc-ID and a new action date, which may reflect one year from the previous action date (or any other suitable time interval). The new record may also specify a Family-ID that matches the Family-ID of the original document 370. In this manner, all documents belonging to the same family may be easily found by querying the document metadata 410 for a particular Family-ID.

FIG. 8 shows an example of alternative method 800 according to another example of the described subject matter.

At 810, the computing platform 320 determines a time at which to update an electronic document 370. The determination is made based on content of the document. For example, the determination identifies an action date specified by the document, such as a renewal date.

At 820, the platform 320 retrieves the document 370 at or prior to the determination of the time. For example, the platform 320 retrieves the document 370 from the object store 350 prior to the identified renewal date.

At 830, the platform 320 extracts data from the document. The extracted data is indicative of at least one change to be made to the document. For example, the extracted data may include a renewal date determined to be present in the document.

At 840, the platform 320 determines at least one modification to the electronic document 370 based on the extracted data. For example, the platform 320 may determine that a renewal date present in the document 370 should be changed to a new renewal date, e.g., one year hence.

At 850, the platform 320 modifies the electronic document to include the at least one modification at or prior to the determined time. This act may include, for example, replacing the original renewal date with the newly determined renewal date, thereby producing a modified document 370a. The modified document 370a may then be distributed to parties for signature.

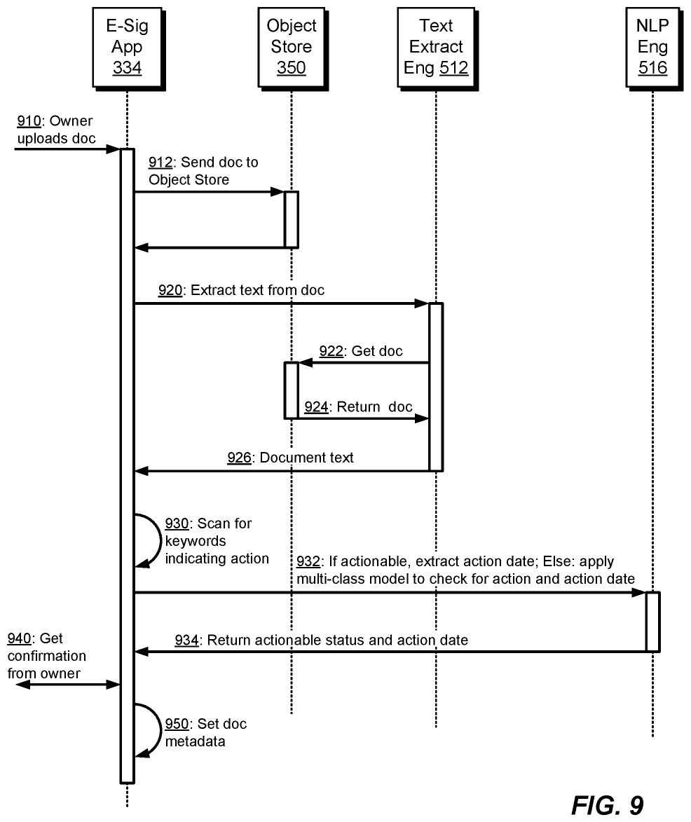

FIG. 9 shows an example sequence of events that may be carried out in accordance with certain embodiments. The depicted events involve the above-described e-signature application 334, object store 350, text extraction engine 512, and NLP (natural language processing) engine 516.

At 910, an entity uploads a document 370 to the e-signature application 334. The entity may be an owner of document 370, or someone working at the behest of the owner.

At 912, the e-signature application 334 submits the document 370 for storage in the object store 150.

At 920, which is generally sometime later, the e-signature application 334 directs the action predictor 510 to extract text from the document 370, e.g., via operation of the text extraction engine 512. At 922 the action predictor 510 requests the document 370 from the object store 350, and at 924 the text extraction engine 512 receives the document 370 and extracts the text of the document 370, e.g., using OCR. At 926 the text extraction engine 512 returns the text of document 370 to the e-signature application 334.

At 930, the e-signature application 334 scans the received document text for keywords that indicate an action, such as renewal. For example, the e-signature application 334 invokes the keyword analyzer 514 to search the document text for keywords indicative of renewal and renewal date.

At 932, if keyword searching is unable to determine that the document is renewable and a renewal date, the e-signature application 334 provides the document text to the multi-class model 530 in the NLP engine 516. The multi-class model 530 then processes the document text to generate a determination of actionable status (e.g., renewable) and an action date. At 934, the determined actionable status and action date are returned to the e-signature application 334.

At 940, the e-signature application 334 obtains and receives confirmation of the actionable status and date, e.g., from the entity/owner. At 950, the e-signature application 334 sets the document metadata, e.g., by creating a new record in the document metadata 410 for the document 370. The new record may include the determined actionable status and action date, as well as other field values.

An improved technique has been described for document management. The technique includes performing a text-based analysis (e.g., by action predictor 510) of a document 370 submitted for signature and/or storage. The text-based analysis searches for terms and/or other content that indicate a future action to be performed and a corresponding action date by which to perform the action. In response to detecting such terms and/or other content, the technique further includes creating metadata indicative of the action and associated action date and storing such metadata in a database 340. The technique further includes querying the database 340, e.g., prior to or upon the action date, and creating a modified version of the document to implement the detected action.

Having described certain embodiments, numerous alternative embodiments or variations can be made. For example, although specified actions and action dates have been described herein as renewals and renewal dates, these are merely examples. Other examples of actions may include document expirations and expiration dates. In such cases, there may be an opportunity to create new documents upon expiration of previous ones. Still other examples of actions may include archiving a document for document retention, deleting a document after expiration of document retention period, finding similar or related documents, creating amendments to documents, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should not be interpreted as meaning “based exclusively on” but rather “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method, comprising:
identifying, based at least in part on a range of dates, an electronic document from a database;
obtaining, from the database, metadata indicative of the electronic document, the metadata including a date and an identifier of an entity of the electronic document;
prior to or upon an occurrence of the date, (i) obtaining the electronic document from a service provider, (ii) generating a modified version of the electronic document, and (iii) transmitting a link to the modified version to the entity; and
based on activation of the link, providing the modified version of the document for signature.

2. The method of claim 1, further comprising modifying the modified version of the electronic document based on changes made by the entity.

3. The method of claim 1, wherein the metadata is further indicative of one or more identifiers of parties to the electronic document, and wherein the method further comprises, based on the activation of the link, sending respective requests for signing the modified version of the document to the parties.

4. The method of claim 1, wherein generating the modified version of the document includes changing the date on the electronic document to a revised date that is later than the date.

5. The method of claim 1, further comprising:
receiving a second document;
identifying an action date specified by the second document;
determining, based on text extracted from the second document, an action specified by the second document in connection with the action date;
sending an electronic message to an entity of the second document, the electronic message requesting confirmation that the action specified by the second document is due for performance by the action date; and
in response to confirmation from the entity of the second document, storing second metadata in the database, the second metadata specifying, in connection with an identifier of the second document, an indicator of the action date and an indicator of the action.

6. The method of claim 5, wherein determining the specified action includes performing keyword analysis on the text extracted from the second document.

7. The method of claim 5, wherein determining the specified action includes performing natural language processing on the text extracted from the second document.

8. The method of claim 7, wherein performing the natural language processing includes providing the extracted text to a machine-learning model trained to detect specified actions and associated action dates.

9. The method of claim 8, further comprising training the machine-learning model at least in part using previously-executed documents stored by the service provider.

10. The method of claim 9, wherein training the machine-learning model includes:
operating the machine-learning model on a first previous document stored by the service provider to generate a prediction that the first previous document is renewable and an associated renewal date; and
providing positive feedback for the prediction made by the machine-learning model responsive to determining that a second previous document stored by the service provider is a renewal of the first previous document.

11. The method of claim 10, further comprising matching the first previous document to the second previous document is based on at least one of:
(i) the first previous document and the second previous document sharing a common owner,
(ii) the first previous document and the second previous document sharing a common set of parties,
(iii) the first previous document and the second previous document having been generated from a common user account, or
(iv) the first previous document and the second previous document having been generated from a common document template.

12. A server, comprising control circuitry constructed and arranged to:
identify, based at least in part on a range of dates, an electronic document from a database;
obtain, from the database, metadata indicative of the electronic document, the metadata including a date and an identifier of an entity of the electronic document;
prior to or upon an occurrence of the date, (i) obtain the electronic document from a service provider, (ii) generate a modified version of the electronic document, and (iii) transmit a link to the modified version to the entity; and
based on activation of the link, provide the modified version of the document for signature.

13. The server of claim 12, wherein the control circuitry constructed and arranged to generate the modified version of the document is further constructed and arranged to change the date on the electronic document to a revised date that is later than the date.

14. The server of claim 12, wherein the control circuitry is further constructed and arranged to:
receive a second document;
identify an action date specified by the second document;
determine, based on text extracted from the second document; an action specified by the second document in connection with the action date;
send an electronic message to an entity of the second document, the electronic message requesting confirmation that the action specified by the second document is due for performance by the action date; and
in response to confirmation from the entity of the second document, store second metadata in the database, the second metadata specifying, in connection with an identifier of the second document, an indicator of the action date and an indicator of the action.

15. The server of claim 14, wherein the control circuitry constructed and arranged to determine the specified action is further constructed and arranged to perform keyword analysis on the text extracted from the second document.

16. The server of claim 14, wherein the control circuitry constructed and arranged to determine the specified action is further constructed and arranged to perform natural language processing on the text extracted from the second document.

17. The server of claim 16, wherein the control circuitry constructed and arranged to perform the natural language processing is further constructed and arranged to provide the extracted text to a machine-learning model trained to detect specified actions and associated action dates.

18. The server of claim 17, wherein the control circuitry is further constructed and arranged to train the machine-learning model at least in part using previously-executed documents stored by the service provider.

19. The server of claim 18, wherein the control circuitry constructed and arranged to train the machine-learning model is further constructed and arranged to:
operate the machine-learning model on a first previous document stored by the service provider to generate a prediction of that the first previous document is renewable and an associated renewal date; and
provide positive feedback for the prediction made by the machine-learning model responsive to determining that a second previous document stored by the service provider is a renewal of the first previous document.

20. A method comprising:
determining, by a computing device, a time at which to update an electronic document, the determination being made based on content of the document;
retrieving, by the computing device, the document from a database at or prior to the determination of the time;
extracting, by the computing device, data from the document, the data being indicative of at least one change to be made to the document;
determining, by the computing device, at least one modification to the electronic document based on the data extracted; and
modifying, by the computing device, the electronic document to include the at least one modification by addition or deletion of content to or from the electronic document at or prior to the determined time.
